(19) United States
(12) Patent Application Publication
(10) Pub. No.: US 2024/0368382 A1
(43) Pub. Date: Nov. 7, 2024

(54) ELASTOMETRIC COMPOSITION HAVING HIGH OZONE RESISTANCE

(71) Applicant: SINTESI E RICERCA S.P.A., Dronero (CN) (IT)

(72) Inventor: Giuseppe Ambroggio, Rivolto (TO) (IT)

(21) Appl. No.: 18/290,859

(22) PCT Filed: Jul. 20, 2022
(86) PCT No.: PCT/IB2022/056698

§ 371 Date: Jan. 22, 2024

(30) Foreign Application Priority Data
Jul. 22, 2021 (IT) 102021000019553

(51) Int. Cl. C08L 7/00; C08K 3/04; C08K 5/18; C08L 9/00

(52) U.S. Cl. CPC C08L 7/00; C08K 3/04; C08K 5/18; C08L 9/00; C08L 2201/08; C08L 2312/00

(57) ABSTRACT

An elastomeric composition comprising at least one elastomeric polymer and at least one long-chain olefin, wherein said at least one long-chain olefin has a number average molecular weight from 180 g/mol to 2000 g/mol, preferably from 300 g/mol to 1500 g/mol, and consists of at least 40% by weight of at least one linear-chain olefin. Said long-chain olefin is particularly effective, alone or mixed with a wax, against the degrading action of elastomeric material caused by atmospheric ozone. In fact, it is able to migrate to the surface in a controlled and gradual manner, so that the protective effect is guaranteed for a long time without causing undesired blooming effects.

The present invention concerns an elastomeric composition having high ozone resistance. In particular, the present invention relates to an elastomeric composition having high ozone resistance and comprising at least one long-chain olefin.

It is well known that prolonged exposure to sunlight and the atmosphere causes premature ageing of elastomeric materials, with deterioration of the surface appearance and formation of micro-cracks, which can eventually cause the material itself to crack. This ageing is mainly caused by the oxidising action of atmospheric ozone, which causes macromolecular chains to break down. In order to prevent these ageing phenomena, suitable additives can be added to the elastomeric compositions, which can act as anti-ozonants or surface protectants. In the first case, anti-ozonants are products (e.g. amines or quinolines) that selectively react with ozone to prevent oxidation of the polymeric material. Conversely, in the second case they are generally waxes that, by migrating onto the surface of the manufactured article, form a thin protective layer that hinders interaction with atmospheric ozone.

The use of waxes in elastomeric compositions can cause certain drawbacks, mainly related to excessive surface migration of the waxes themselves (the so-called “blooming”), which gives the manufactured article an undesirable whitish surface colour, as well as reducing the duration of the protective effect against the action of ozone.

A possible solution to the aforementioned problem is offered, for example, by the elastomeric compositions described in WO 2004/014996, which are particularly suitable for manufacturing tyres and comprise at least one elastomeric diene polymer, at least one paraffin wax and at least one polymer of at least one C₃-C₂₄ α-olefin, said polymer having a number average molecular weight of no more than 10,000. The addition of such a polymer to a paraffin wax would improve ozone resistance without causing undesirable changes in the surface colour of the manufactured article. This polymer is characterised by a high degree of branching, in particular a molar ratio of methyl groups to the total number of carbon atoms from 1% to 20% by mole, or also a molar ratio of tertiary carbon atoms to the total number of carbon atoms of 1 to 20% by mole. The amount of polymer to be added varies from 0.1% to 10% by weight, preferably 0.5% to 5% by weight, with respect to the weight of the paraffin wax. Examples of polymers suitable for this purpose are Baker Petrolite Corp.'s VYBAR™ products, which are characterised by a high degree of branching.

The Applicant believes that the solution described in WO 2004/014996 is in fact not useful from an industrial point of view, as the action of the branched polymer in counteracting “blooming” is limited to high crystallinity waxes, as this polymer acts as a crystallisation seed preventing the formation of large wax crystals, which are one of the causes of surface whitening. This effect is not useful when using microcrystalline or amorphous waxes, which are now the most widely used ozone protective agents, where crystallinity is absent or the crystals are in fact of small size.

Therefore, the Applicant has been faced with the problem of finding an elastomeric composition with high ozone resistance in which an additive is present that is effective in reducing the degradation effects of ozone and that does not migrate too quickly onto the surface of the elastomeric material, so that it retains its original appearance for a long time, without formation of opacity and/or whitening.

The Applicant considers that the protective mechanism of an additive, which is particularly effective against the action of atmospheric ozone on an elastomeric material, must essentially be based on the ability of the additive to migrate to the surface in a controlled and gradual manner, so as to guarantee the protective effect for a long time without causing undesirable blooming effects. In particular, the Applicant considers that such a balance of properties cannot be achieved by an additive such as that described in WO 2004/014996, whose mechanism of action is based solely on its ability to render paraffin waxes amorphous.

The Applicant has now found that it is possible to achieve the above-mentioned objectives and others which will be better explained below by addition to an elastomeric composition of at least one long-chain olefin having a number average molecular weight of 180 g/mol to 2000 g/mol, preferably 300 g/mol to 1500 g/mol, in which at least 40% by weight is made up of at least one linear-chain olefin. Thanks to the presence of an olefin group, this product is provided with a weak polarity that is able to regulate migration on the surface, achieving a correct balance that allows for a sufficient quantity of additive on the surface to protect the material from the aggression of ozone, but not excessive so as to prevent the drawbacks caused by blooming as illustrated above.

This migration control is also achieved by a careful choice of the olefin molecular weight within the above-mentioned values, and can be further improved by the possible concomitant use of other waxes protecting against the action of ozone, which, as they do not have charge dislocation typical of the olefin double bond, migrate faster to the surface than olefins. By adjusting the proportion of olefin to additional wax, both anti-ozone protection and migration rate can be controlled extremely finely, preventing blooming and ensuring a protective effect over time.

Patent application EP 3 851 487 A1 describes an elastomeric composition comprising: (a) a copolymer containing conjugated diene units, non-conjugated olefin units and aromatic vinyl units, and (b) an alpha-olefin having a number average molecular weight (Mn) of 50 to 1,000. The addition of alpha-olefin (b) would have the function of improving processability of the copolymer (a), which has the disadvantage of excessively increasing viscosity of the unvulcanised composition. The copolymer (a) is specifically a copolymer between 1,3-butadiene, ethylene and styrene. The alpha-olefin (b) is added in an amount of 10 to 80 phr, preferably 15 to 60 phr, more preferably 20 to 55 phr.

According to a first aspect, the present invention thus relates to an elastomeric composition comprising at least one elastomeric polymer and at least one long-chain olefin, wherein:
said at least one long-chain olefin has a number average molecular weight of 180 g/mol to 2000 g/mol, preferably 300 g/mol to 1500 g/mol, and consists of at least 40% by weight of at least one linear-chain olefin;
the elastomeric composition does not include a copolymer containing conjugated diene units, non-conjugated olefin units and aromatic vinyl units.

Preferably, in said at least one long-chain olefin at least 50%, more preferably at least 70% by weight, even more preferably at least 80% by weight, consists of at least one linear-chain olefin.

As for the position of the double bond along the chain, this can be terminal or internal. Preferably, said at least one long-chain olefin predominantly contains, or essentially consists of, at least one linear α-olefin, i.e., an olefin with a terminal double bond.

“Average molecular weight” means the actual molecular weight of the olefin when it is a single product, or the number average molecular weight in the case of a mixture of different olefins. The number average molecular weight can be determined by known techniques, in particular by gas chromatography.

The amount of linear-chain olefins can be determined by known techniques, in particular by gas chromatography or NMR spectroscopy.

For the purposes of the present invention, in the following description and claims definitions of numerical ranges include the individual values within the range and its extremes, unless otherwise specified.

For the purposes of the present invention, in the description and the following claims, the term “comprising” also includes the terms “which essentially consists of” or “which consists of”.

According to another aspect, the present invention relates to the use of a composition as described above for the production of tyres, conveyor belts, transmission belts, or hoses.

According to another aspect, the present invention relates to the use of at least one long-chain olefin in an elastomeric composition as a protective agent against the action of ozone, said at least one long-chain olefin having a number average molecular weight from 180 g/mol to 2000 g/mol, preferably from 300 g/mol to 1500 g/mol, and consisting at least 40% by weight of at least one linear-chain olefin.

Long-chain olefins, and in particular linear long-chain α-olefins (LAO), are products known in the art and are generally produced by oligomerisation of ethylene, with the formation of a mixture of olefins, mostly α-olefins, having a high amount of linear chains with an even number of carbon atoms, possibly mixed with smaller amounts of branched isomers and/or internal olefins and paraffin impurities. The major producers of LAO are Chevron Phillips Chemicals (CPChem), Shell and Ineos.

Further information on LAOs and their production can be found for example in Chemical Economics Handbook, Linear alpha-Olefins (November 2010) by E. O. Camara Greiner et al (available at https://cdn.ihs.com/www/pdf/CEH-Linear-Alpha-Olefins-sample-report-2010.pdf) and in the article by Talwinder Singh et al, Intl. J. Engineering Applied Sciences and Technology, 2017, vol. 2, Issue 4, ISSN No. 2455-2143, p. 83-86.

The composition according to the present invention comprises said at least one long-chain olefin in an amount preferably comprised between 0.005 phr and 15 phr, more preferably between 0.01 phr and 10 phr (phr=parts by weight with respect to 100 parts by weight of elastomeric polymer(s)). Preferably, the amount of said at least one long-chain olefin is less than or equal to 9 phr, more preferably less than or equal to 8 phr.

The composition according to the present invention may comprise said at least one long-chain olefin as the only protective compound against the action of ozone.

Alternatively, the composition according to the present invention may additionally comprise at least one wax. The wax can preferably be chosen from: paraffin petroleum waxes, Fischer-Tropsch process waxes, microcrystalline waxes, natural waxes, mineral waxes, vegetable waxes, polyethylene waxes, or mixtures thereof, or refining products thereof. The amount of said at least one wax is preferably comprised between 0.005 phr and 15 phr, more preferably between 0.01 phr and 10 phr.

In case at least one wax is also present, the weight ratio between said at least one long-chain olefin and said at least one wax is preferably comprised between 5:95 and 95:5, more preferably between 20:80 and 80:20.

With regard to the polymer base of the compositions according to the present invention, this consists of or comprises at least one elastomeric polymer. The elastomeric polymer can be cross-linked or thermoplastic (TPE). The elastomeric polymer can be selected from a wide range of products known in the art, in particular from:
(a) ethylene-propylene (EPR) or ethylene-propylene-diene (EPDM) copolymers;
(b) polyisobutylene, butyl or halobutyl rubbers (especially chlorobutyl or bromobutyl);
(c) diene elastomeric polymers;
(d) polyurethane elastomeric polymers;
(e) silicone elastomeric polymers.

As mentioned above, copolymers containing conjugated diene units, non-conjugated olefin units and aromatic vinyl units, as described in patent application EP 3 851 487 A1, are excluded.

Elastomeric polymers are usually cross-linked, either by peroxides or by sulphur cross-linking.

Sulphur-crosslinked diene elastomeric polymers are particularly preferred, namely: cis-1,4-polyisoprene (natural or synthetic); 3,4-polyisoprene; polybutadiene; isoprene/isobutene copolymers, possibly halogenated; 1,3-butadiene/acrylonitrile copolymers; styrene/1,3-butadiene copolymers; styrene/isoprene/1,3-butadiene copolymers; styrene/1,3-butadiene/acrylonitrile copolymers; or mixtures thereof.

The elastomeric composition in accordance with the present invention may contain other products chosen according to the specific applications for which the compositions are intended. For example, the composition may comprise: reinforcing fillers, antioxidants, anti-ageing additives, coupling agents for reinforcing fillers, plasticisers, adhesives, modifying resins, fibres, or mixtures thereof.

In the case of reinforcing fillers, these are preferably added in an amount of 0.1 phr to 120 phr, more preferably 20 phr to 90 phr. They can be selected in particular from carbon black, silica, alumina, aluminosilicates, calcium carbonate, kaolin, or mixtures thereof.

The elastomeric composition according to the present invention can be prepared according to known techniques by mixing the elastomeric polymer base with the long-chain olefin and any other components of the compound. Mixing can be carried out, for example, in an open or internal batch mixer, e.g. a mixer with tangential (Banbury) or interpenetrating (Intermix) rotors. Alternatively, continuous mixers can be used, e.g. ko-kneaders (Buss) or single or twin-screw extruders (co-rotating or counter-rotating).

The elastomeric compositions according to the present invention can be used for manufacturing various articles, for example for manufacturing tyres, conveyor belts, transmission belts, hoses, and other manufactured articles where high elastic performance and durability are required. The compositions according to the present invention are particularly adapted for manufacturing tyres, especially for tyre sidewalls where degradation due to atmospheric ozone is most pronounced and can impair flexural strength.

The following embodiment examples are provided merely to illustrate the present invention and should not be construed in a sense that would limit the scope of protection defined by the claims.

### EXAMPLES 1-2

Two compositions were prepared with the formulations shown in Table 1 (quantities are given in phr, i.e. parts by weight per 100 parts by weight of elastomers).

The method of preparing the compositions was as follows. All the ingredients, with the exception of sulphur and vulcanisation accelerator (CBS), were mixed in an internal mixer (Pomini model PL 1.6) for about 5 min (1st step). As soon as the temperature inside the mixer reached 145±5° C., the composition was unloaded and sulphur and accelerator were added. The mixing was completed in an open roll mill.

TABLE 1

| | | |
|---|---|---|
| EXAMPLE | 1 ⁽*⁾ | 2 |

1st step

| | | |
|---|---|---|
| NR | 50 | 50 |
| BR | 50 | 50 |
| Carbon black | 60 | 60 |
| Zinc oxide | 3 | 3 |
| Aromatic oil | 15 | 15 |
| Antioxidant | 4 | 4 |
| Paraffin wax | 2 | 1 |
| Long-chain olefin | — | 1 |

2nd step

| | | |
|---|---|---|
| CBS | 1 | 1 |
| Sulphur | 2 | 2 |

⁽*⁾ comparative
NR: natural rubber;
BR: cis-1,4-polybutadiene (Europrene ® Neocis BR40 - Versalis SpA);
Carbon black: N330 (Vulcan ® R.3 - Cabot Corp.);
Antioxidant: phenyl-p-phenylenediamine;
Paraffin wax: Wax SER 8553 (SER SpA);
Long-chain olefin: Neodene ® 26+ (Shell Chemicals LP), having a content of linear olefins having at least 26 carbon atoms of approximately 85% by weight;
CBS (accelerator): N-cyclohexyl-2-benzothiazyl-sulfenamide (Vulkacit ® CZ - Lanxess).
Paraffin wax was characterised by: freezing point: 67-73° C. (ASTM D938-12); needle penetration (@25° C. ASTM D1321-16a): 20 dmm (max).
Long-chain olefin was characterised by: freezing point: 59° C.; needle penetration (@25° C. - ASTM D1321-16a): 12 dmm; kinematic viscosity (@100° C. - ASTM D445-06).

Each composition was calendered to obtain samples of 20 mm width and 2 mm thickness, which were then vulcanised at 160° C. for 20 min.

### Ozone Resistance Test.

Each specimen was placed in a frame provided with clamps to which the specimen ends were hooked. Manual traction was applied until 20% elongation was reached, which was maintained by the clamps. Each elongated specimen was placed in a test chamber (ventilated Agrolab ICR-150 incubator) in order to assess the degradation of the material caused by exposure to ozone. Ozone was then fed into the chamber at a concentration of 50 pphm (parts per hundred million). Maintaining the temperature in the chamber at 38° C. (1st series) or 50° C. (2nd series), each specimen was kept under the action of ozone for 24, 48 and 72 hours. At the end of each time interval, the appearance of the specimen was visually examined: none of the specimens showed any cracking, even after 72 hours at 50° C., so that both compounds demonstrated excellent ozone resistance.

### Blooming Test.

From each sample of composition obtained after calendering, three specimens, weighing 40±1 g, were obtained. The specimens were placed in a cylindrical mould with a diameter of 65 mm and a height of 10 mm and vulcanised for 15 min at 170° C. using a laboratory press by Gibitre Srl. The vulcanisation cycle included two degassing stages, in accordance with the press specification.

At the end of the vulcanisation cycle, the specimens were carefully removed from the mould and conditioned at room temperature for 24 hours in the dark. After conditioning, the specimens were placed in an incubator at a temperature of 30±0.5° C. under forced ventilation and kept under these conditions for 7, 14 or 21 days.

After ageing was completed, the specimens were removed from the incubator and allowed to condition at room temperature for 15 min.

After being weighed on an analytical balance, recording the initial weight (Pᵢ), the wax that had bloomed on the surface was carefully removed with a razor. After removal, the specimens were weighed again on an analytical balance to measure the final weight (P_{f}).

Blooming was determined as mg of wax bloom (average over the three samples A, B, C) according to the following formula (measurement limit: 0.3 mg):

$${mg}_{wax} = [ {( {P}_{i} - {P}_{f} )}_{A} + {( {P}_{i} - {P}_{f} )}_{B} + {( {P}_{i} - {P}_{f} )}_{c} ] / 3$$

The results are reported in Table 2.

TABLE 2

| | |
|---|---|
| Example 1 ⁽*⁾ | Example 2 |

| | |
|---|---|
| Incubation time | mg_{wax} |

| | | |
|---|---|---|
| 7 days | 1.9 | 0.8 |
| 14 days | 3.3 | 1.6 |
| 21 days | 7.1 | 1.8 |

⁽*⁾ comparative

From the data shown in Table 2, a considerable reduction in the amount of wax surfaced in the specimens made according to the invention compared to the comparison specimens can be seen, resulting in a longer ozone protection period and a substantial reduction in blooming.

### EXAMPLE 3

To further verify the efficacy of the long-chain olefin in reducing the blooming effect, the same composition as in Example 2 was made with gradually increasing amounts of long-chain olefin replacing the paraffin wax, up to 100% by weight of long-chain olefin, while maintaining the same total amount of waxes (2 phr). The blooming tests were then carried out as described above.

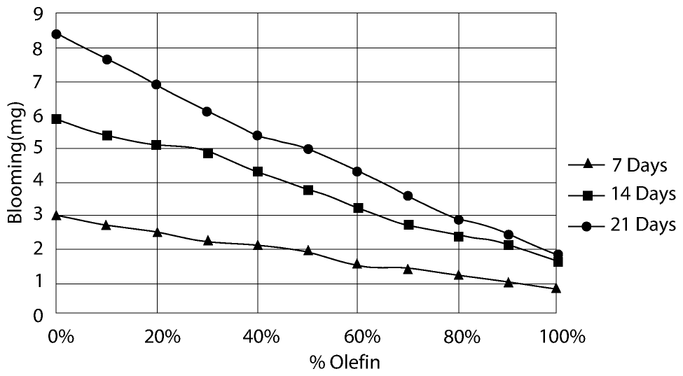

The results (expressed as mg_{wax} averaged over three samples) are shown in Table 3 and the graph in FIG. 1:

TABLE 3

| % by weight of long- | Incubation time | | |
|---|---|---|---|
| chain olefin | 7 days | 14 days | 21 days |
| 0 | 3.0 | 5.9 | 8.4 |
| 10 | 2.7 | 5.4 | 7.6 |
| 20 | 2.5 | 5.1 | 6.9 |
| 30 | 2.2 | 4.9 | 6.1 |
| 40 | 2.1 | 4.3 | 5.4 |
| 50 | 1.9 | 3.8 | 5.0 |
| 60 | 1.5 | 3.2 | 4.3 |
| 70 | 1.4 | 2.7 | 3.6 |
| 80 | 1.2 | 2.4 | 2.9 |
| 90 | 1.0 | 2.1 | 2.4 |
| 100 | 0.8 | 1.6 | 1.8 |

It is clear from the tests carried out that the present invention makes it possible to regulate rate and quantity of wax migrating to the surface, so that elastomeric compositions can be tailored to their intended use, particularly with regard to operating and/or climatic conditions of use, while maintaining the quality of ozone protection and preventing the problem of blooming.

1. Elastomeric composition which comprises at least one elastomeric polymer and at least one long-chain olefin, wherein:
said at least one long-chain olefin has a number average molecular weight of 180 g/mol to 2000 g/mol, and consists of at least 40% by weight of at least one linear-chain olefin;
the elastomeric composition does not include a copolymer containing conjugated diene units, non-conjugated olefin units and aromatic vinyl units.

2. The composition according to claim 1, wherein said at least one long-chain olefin has an average (numerical) molecular weight from 300 g/mol to 1500 g/mol.

3. The composition according to claim 1, wherein said at least one long-chain olefin comprises at least 50%, preferably at least 70% by weight, more preferably at least 80% by weight, of the at least one linear-chain olefin.

4. The composition according to claim 1, wherein said at least one long-chain olefin predominantly contains, or essentially consists of, at least one linear α-olefin.

5. The composition according to claim 1, wherein said at least one long-chain olefin is present in an amount comprised between 0.005 phr and 15 phr (phr=parts by weight with respect to 100 parts by weight of elastomeric polymer(s)).

6. The composition according to claim 1, wherein said at least one long-chain olefin is present in an amount not exceeding 9 phr.

7. The composition according to claim 1, which comprises at least one long-chain olefin as the sole protective compound against the action of ozone.

8. The composition according to claim 1, which further comprises at least one wax.

9. The composition according to claim 8, wherein said at least one wax is chosen from: paraffin petroleum waxes, Fischer-Tropsch process waxes, microcrystalline waxes, natural waxes, mineral waxes, vegetable waxes, polyethylene waxes, or mixtures thereof, or refining products thereof.

10. The composition according to claim 8, wherein said at least one wax is present in an amount comprised between 0.005 phr and 15 phr, preferably between 0.01 phr and 10 phr.

11. The composition according to claim 8, wherein the weight ratio between said at least one long-chain olefin and said at least one wax is comprised between 5:95 and 95:5.

12. The composition according to claim 1, wherein said at least one elastomeric polymer is selected from:
(a) ethylene-propylene (EPR) or ethylene-propylene-diene (EPDM) copolymers;
(b) polyisobutylene, butyl or halobutyl rubbers (especially chlorobutyl or bromobutyl);
(c) diene elastomeric polymers;
(d) polyurethane elastomeric polymers;
(e) silicone elastomeric polymers.

13. The composition according to claim 12, wherein said at least one elastomeric polymer is cross-linked, either by peroxides or by sulphur cross-linking.

14. The composition according to claim 1, further comprising at least one reinforcing filler.

15. Use of a composition according to claim 1 for the manufacture of tyres, conveyor belts, transmission belts, or hoses.

16. Use of at least one long-chain olefin in an elastomeric composition as a protective agent against the action of ozone, said at least one long-chain olefin having a number average molecular weight from 180 g/mol to 2000 g/mol, and consisting of at least 40% by weight of at least one linear-chain olefin.
